(19) United States
(12) Patent Application Publication
(10) Pub. No.: US 2007/0203654 A1
(43) Pub. Date: Aug. 30, 2007

(54) Measuring apparatus, and measuring method

(75) Inventor: Toshihide Ezoe, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/520,835

(22) Filed: Sep. 14, 2006

(30) Foreign Application Priority Data
Sep. 27, 2005 (JP) 2005-280832
Sep. 27, 2005 (JP) 2005-280833
Sep. 27, 2005 (JP) 2005-280834

(51) Int. Cl. G06F 19/00; G01J 3/45

(52) U.S. Cl. 702/19; 702/22; 356/452

(57) ABSTRACT

A measuring method, including storing reference data for two or more previously determined types of examination object compounds, so as to provide a correspondence with each of the compounds; supplying a compound to a biologically active substance attached on an attachment film to measure the interaction of said compound with said attachment film on which said biologically active substance is attached; correcting the measurement data obtained by the measurement with the reference data corresponding to the compound to calculate interaction data for the interaction between the biologically active substance and said compound.

### CROSS-REFERENCE TO RELATED APPLICATIONS

This application claims priority under 35USC 119 from Japanese Patent Application, insert identifying information for all JP priority application Nos. 2005-280832, 2005-280833, 2005-280834, the disclosure of which is incorporated by reference herein.

### BACKGROUND OF THE INVENTION

1. Field of the Invention

The present invention relates to a measuring apparatus and a measuring method, and particularly, relates to a measuring apparatus for measuring the interaction between a biologically active substance and a prescribed compound, and a measuring method for the same.

2. Description of the Related Art

As the apparatus for measuring the interaction between a biologically active substance and a prescribed compound, various biosensors have been proposed. Among these, as one of the measuring apparatuses utilizing the evanescent wave, the surface plasmon sensor is known (referring to Japanese Patent No. 3294605). Generally, the surface plasmon sensor comprises a prism; a metal film which is disposed on one face of this prism, and on which a biologically active substance is attached; a light source which emits a light beam; an optical system which irradiates the light beam to the prism at various angles such that a total reflection condition is provided at the boundary between the prism and the metal film; and light detection means which detects the intensity of the light beam totally reflected at the boundary, and on the basis of the detection result by the light detection means, carries out measurement for the biologically active substance.

In measurement with this surface plasmon sensor, a compound solution is supplied to the biologically active substance which is attached on the metal film; a light beam is irradiated to the face of the metal film on the side reverse to that on which the compound solution is supplied; and on the basis of the information about the refractive index that is obtained from the reflected light therefrom, the interaction between the biologically active substance and the compound in the compound solution is measured.

By the way, for measurement with the surface plasmon sensor, a reference part where no biologically active substance is attached is provided, besides the measuring section where the biologically active substance is attached, and using the information about the refractive index that is obtained from the reference part, the information about the refractive index for the measuring section is corrected. The main purpose of the correction as mentioned herein is to cancel the signal variation between the compound and the attachment film that comes from the difference in type and other conditions, and measure only the signal variation due to the specific coupling between the biologically active substance and the compound.

However, if, in addition to the measuring section, the reference part must be provided, and also for the reference part, the refractive index information must be obtained, there arises the need for giving the time period of measurement by the reference part, resulting in the throughput time being extended. In addition, if the measurement by the measuring section and that by the reference part is carried out concurrently, the configuration of the apparatus will be rendered intricate.

In addition, when the examination object compound is to be adsorbed on the attachment film in quantity (hereinafter such an adsorption is referred to as “a non-specific adsorption”), the possibility of the specific coupling between the biologically active substance and the compound being not accurately measured is high.

### SUMMARY OF THE INVENTION

The measuring apparatus of a first aspect provides a measuring apparatus which, on the basis of measurement data which is obtained by supplying an examination object compound to a measurement region in which a biologically active substance is attached on an attachment film, and reference data including information about the amount of non-specific adsorption of said compound on said attachment film that is obtained by supplying said compound to a reference region made up of said attachment film on which said biologically active substance is not attached, measures the interaction between said biologically active substance and said compound, the apparatus comprising: a memory section which stores, in advance, said reference data for two or more types of said examination object compound for each said compound; a measuring section which supplies said compound to the biologically active substance attached on said attachment film and measures the interaction of said compound with said attachment film on which said biologically active substance is attached; a calculation section which corrects the measurement data obtained by measurement by said measuring section with said reference data corresponding to said compound to calculate interaction data for the interaction between said biologically active substance and said compound; and an output section which outputs the interaction data calculated by said calculation section.

In addition, the measuring method of a second aspect provides a measuring method which, on the basis of measurement data which is obtained by supplying an examination object compound to a measurement region in which a biologically active substance is attached on an attachment film, and reference data including information about the amount of non-specific adsorption of said compound on said attachment film that is obtained by supplying said compound to a reference region made up of said attachment film on which said biologically active substance is not attached, measures the interaction between said biologically active substance and said compound, the method comprising: storing said reference data for two or more previously determined types of said examination object compound, so as to provide a correspondence with each said compound; supplying said compound to the biologically active substance attached on said attachment film and measuring the interaction of said compound with said attachment film on which said biologically active substance is attached; correcting the measurement data obtained by said measurement with said reference data corresponding to said compound to calculate interaction data for the interaction between said biologically active substance and said compound; and outputting said calculated interaction data.

Herein, said biologically active substance means a substance containing any one or more of the substances mentioned as “naturally-occurring high polymers” (Nos. 11001 to 11025) in Japan Industrial Standard (JIS) K3611 “Technical terms for biological engineering (biosystem)”; the sugar, amino acid, nucleotide, lipid, heme, quinone, protein, RNA, DNA, phospholipid, and polysaccharide as mentioned in “II Biochemistry 1. Outline of biological substances” in “Encyclopedia Databook of Biology” (Asakura Publishing Co., Ltd.); and the protein, amino acid, nucleic acid, lipid, glucide, and enzyme as mentioned in “II. Biological substances and metabolism” in “Bioscience Dictionary” (Asakura Publishing Co., Ltd.).

Said interaction means the velocity of coupling reaction, the amount of coupling, or the velocity of dissociation in the physical, chemical, or biochemical reaction, or a combination of any two, or more, of the velocity of coupling reaction, the amount of coupling, and the velocity of dissociation as mentioned above.

When, for a given biologically active substance, a plurality of types of compound are supplied to measure the interaction, the signal obtained greatly varies depending upon the type of compound. Then, the reference data including the adsorption state between the attachment film for attaching a biologically active substance and each of the previously determined two or more types of examination object compound is stored. And, with this reference data, the measurement data is corrected. Thereby, for the signal variate that varies with each particular compound, correction can be performed, and thus there is no need for obtaining the reference data every time the measurement is performed, which allow the throughput time to be shortened. In addition, for the measuring apparatus, the need for having a system for acquiring the reference data is eliminated, thus the structure of the apparatus can be simplified.

The measuring apparatus of the first aspect may be adapted to provide the measuring apparatus of the first aspect, wherein said attachment film is formed on a metal film; and said measuring section utilizes the total reflection attenuation caused by irradiating a light beam to the side of said metal film on which said attachment film is not formed, for measuring the interaction of said compound with said attachment film on which said biologically active substance is attached.

In addition, the measuring method of the second aspect may be adapted to provide the second aspect, wherein said measurement utilizes the total reflection attenuation caused by irradiating a light beam on a metal film, which has said attachment film formed on one face thereof, at a side of the metal film at which said attachment film is not formed, for measuring the interaction of said compound with said attachment film on which said biologically active substance is attached.

As the measurement as described above, the measurement using the surface plasmon sensor, or the leakage mode sensor can be mentioned.

The measuring apparatus of a third aspect provides a measuring apparatus which, on the basis of measurement data which is obtained by supplying an examination object compound to a measurement region in which a biologically active substance is attached on an attachment film, and reference data including information about the amount of non-specific adsorption of said compound on said attachment film that is obtained by supplying said compound to a reference region made up of said attachment film on which said biologically active substance is not attached, measures the interaction between said biologically active substance and said compound, the apparatus comprising: a memory section which stores said reference data for each set of measuring conditions and each said compound; a measuring condition input section which inputs a set of measuring conditions for said measurement; a compound extraction section which extracts the compounds corresponding to the reference data exceeding a prescribed non-specific adsorptivity level of said reference data which corresponds to said inputted set of measuring conditions; a measuring section which supplies each of the compounds except the compounds extracted by said compound extraction section from a group of examination object compounds, to said measurement region and said reference region to acquire the measurement data from said measurement region and the reference data from said reference region, and measure the interaction between said biologically active substance and the supplied compound; an output section which outputs interaction data for the interaction measured by said measuring section; and a feedback section which causes the reference data obtained by said measuring section to be stored in said memory section together with the set of measuring conditions in said measurement.

In addition, the measuring method of a fourth aspect provides a measuring method which, on the basis of measurement data which is obtained by supplying an examination object compound to a measurement region in which a biologically active substance is attached on an attachment film, and reference data including information about the amount of non-specific adsorption of said compound on said attachment film that is obtained by supplying said compound to a reference region made up of said attachment film on which said biologically active substance is not attached, measures the interaction between said biologically active substance and said compound, the method comprising: storing said reference data for each set of measuring conditions and each said compound, inputting a set of measuring conditions for said measurement; extracting the compounds corresponding to the reference data exceeding a prescribed non-specific adsorptivity level of said reference data which corresponds to said inputted set of measuring conditions; supplying each of the compounds except the compounds extracted by said compound extraction section from a group of examination object compounds, to said measurement region and said reference region to acquire the measurement data from said measurement region and the reference data from said reference region, and measure the interaction between said biologically active substance and the supplied compound; outputting interaction data for the interaction measured by said measurement; and causing the reference data obtained by said measurement part to be stored together with the set of measuring conditions in said measurement.

The attachment film on which a biologically active substance is attached and the attachment film on which no biologically active substance is attached differ in amount of non-specific adsorption of compound from each other. Therefore, when the amount of non-specific adsorption of a compound on the attachment film is large, in other words, the reference data exceeds a prescribed non-specific adsorptivity level, the possibility of the interaction between the biologically active substance and the compound being not accurately measured is high.

Then, of the reference data corresponding to the set of measuring conditions inputted for measurement, the reference data which exceeds a prescribed non-specific adsorptivity level is heeded, and the compounds corresponding to this reference data are extracted. And, each of the compounds except the compounds extracted by said compound extraction section from a group of examination object compounds is supplied to said measurement region and said reference region for acquiring the measurement data from said measurement region and the reference data from said reference region, and measuring the interaction between said biologically active substance and the compound supplied.

In this manner, the compounds which are inadequate with respect to the set of measuring conditions are excluded before the measurement, thus wasteful measurement will not be made, and a high efficiency is assured for the measurement.

In addition, the reference data obtained by the measurement is stored together with the set of measuring conditions used in the measurement, thus every time the measurement is performed, the reference data is accumulated, and by repeating the measurement, an adequate measurement can be performed on the basis of a number of pieces of reference data.

The measuring apparatus of the third aspect may be adapted to provide the measuring apparatus of the third aspect, wherein said attachment film is formed on a metal film; and said measuring section utilizes the total reflection attenuation caused by irradiating a light beam to the side of said metal film on which said attachment film is not formed, for measuring the interaction of said compound with said attachment film on which said biologically active substance is attached.

In addition, the measuring method of the fourth aspect may be adapted to provide the measuring method of the fourth aspect, wherein said measurement utilizes the total reflection attenuation caused by irradiating a light beam on a metal film, which has said attachment film formed on one face thereof, at a side of the metal film at which said attachment film is not formed, for measuring the interaction of said compound with said attachment film on which said biologically active substance is attached.

As the measurement as described above, the measurement using the surface plasmon sensor, or the leakage mode sensor can be mentioned.

The measuring apparatus of a fifth aspect provides a measuring apparatus which, on the basis of measurement data which is obtained by supplying an examination object compound to a measurement region in which a biologically active substance is attached on an attachment film, and reference data including information about the amount of non-specific adsorption of said compound on said attachment film that is obtained by supplying said compound to a reference region made up of said attachment film on which said biologically active substance is not attached, measures the interaction between said biologically active substance and said compound, the apparatus comprising: a memory section which stores said reference data for each set of measuring conditions and each said compound; a measuring condition input section which inputs a part of a set of measuring conditions for said measurement; a measuring condition determination section which, on the basis of said reference data corresponding to said inputted part of the set of measuring conditions, determines the other measuring condition such that the non-specific adsorption of the examination object compound on said attachment film is minimized; a measuring section which, under said determined set of measuring conditions, measures the interaction between said biologically active substance and the supplied compound;

an output section which outputs interaction data for the interaction measured by said measuring section; and a feedback section which causes the reference data obtained by said measuring section to be stored in said memory section together with the set of measuring conditions in said measurement.

In addition, the measuring method of a sixth aspect provides a measuring method which, on the basis of measurement data which is obtained by supplying an examination object compound to a measurement region in which a biologically active substance is attached on an attachment film, and reference data including information about the amount of non-specific adsorption of said compound on said attachment film that is obtained by supplying said compound to a reference region made up of said attachment film on which said biologically active substance is not attached, measures the interaction between said biologically active substance and said compound, the method comprising: storing said reference data for each set of measuring conditions and each said compound; inputting a part of a set of measuring conditions for said measurement; on the basis of said reference data corresponding to said inputted part of the set of measuring conditions, determining the other measuring condition such that the non-specific adsorption of the examination object compound on said attachment film is minimized; under said determined set of measuring conditions, measuring the interaction between said biologically active substance and the supplied compound; outputting interaction data for the interaction measured by said measurement; and causing the reference data obtained by said measurement to be stored together with the set of measuring conditions in said measurement.

The attachment film on which a biologically active substance is attached and the attachment film on which no biologically active substance is attached differ in amount of non-specific adsorption of compound from each other. Therefore, when the amount of non-specific adsorption of a compound on the attachment film is large, the possibility of the interaction between the biologically active substance and the compound being not accurately measured is high.

On the other hand, the amount of non-specific adsorption of a particular compound on the attachment film varies depending upon the set of measuring conditions, i.e., the type of the attachment film, the type of the buffer liquid, and the compound concentration, and the type of the compound.

Then, in the present invention, only a part of a set of measuring conditions for measurement is inputted, and the reference data corresponding to the inputted part of the set of measuring conditions is heeded. And, on the basis of the reference data, the other measuring condition is determined such that the non-specific adsorption of the examination object compound on said attachment film is minimized. And, under the determined set of measuring conditions, the interaction between the biologically active substance and the compound supplied is measured.

In the present invention, the set of measuring conditions is determined such that the non-specific adsorption is minimized, and under the determined set of measuring conditions, the measurement is carried out, which allows an accurate measurement to be performed under a more adequate set of measuring conditions.

In addition, in the present invention, the reference data obtained by the measurement is stored together with the set of measuring conditions used in the measurement, thus every time the measurement is performed, the reference data is accumulated, and by repeating the measurement, an adequate measurement can be performed on the basis of a number of pieces of reference data.

The measuring apparatus of the fifth aspect may be adapted to provide measuring apparatus of the fifth aspect, wherein said attachment film is formed on a metal film, and said measuring section utilizes the total reflection attenuation caused by irradiating a light beam to the side of said metal film on which said attachment film is not formed, for measuring the interaction of said compound with said attachment film on which said biologically active substance is attached.

In addition, the measuring method of the sixth aspect may be adapted to provide the measuring method of the sixth aspect, wherein said measurement utilizes the total reflection attenuation caused by irradiating a light beam on a metal film, which has said attachment film formed on one face thereof, at a side of the metal film at which said attachment film is not formed, for measuring the interaction of said compound with said attachment film on which said biologically active substance is attached.

### BRIEF DESCRIPTION OF THE DRAWINGS

FIG. 1 is a general perspective side view of the biosensor;

FIG. 2 is a perspective side view of the sensor stick;

FIG. 3 is an exploded perspective side view of the sensor stick;

FIG. 4 is a sectional view of the liquid flow path portion of the sensor stick;

FIG. 5 is a drawing illustrating the state in which a light beam is irradiated to the measurement region of the sensor stick;

FIG. 6A to FIG. 6C are side views of the pipette part constituting the liquid supply/discharge part;

FIG. 7 is a schematic drawing for the area around the optical measuring section of the biosensor;

FIG. 8 is a schematic block diagram of the control section and the peripheral thereof;

FIG. 9 is a drawing illustrating a correction data base which is used in the first measurement processing;

FIG. 10 is a flowchart for the first measurement processing;

FIG. 11 is a drawing illustrating a non-specific adsorption data base which is used in the second measurement processing;

FIG. 12 is a flowchart for the second measurement processing;

FIG. 13 is a drawing illustrating a non-specific adsorption data base which is used in the third measurement processing;

FIG. 14 is a flowchart for the third measurement processing;

FIG. 15 provides examples of sample data which has been selected in the third measurement processing; and

FIG. 16 is a flowchart for the measurement steps in the third measurement processing.

### DETAILED DESCRIPTION OF THE INVENTION

Hereinbelow, an embodiment of the present invention will be described with reference to the drawings.

A biosensor 10 as a measuring apparatus of the present embodiment is a so-called surface plasmon sensor which utilizes the surface plasmon resonance occurring at the surface of a metal film for measuring the interaction between a biologically active substance D and a compound.

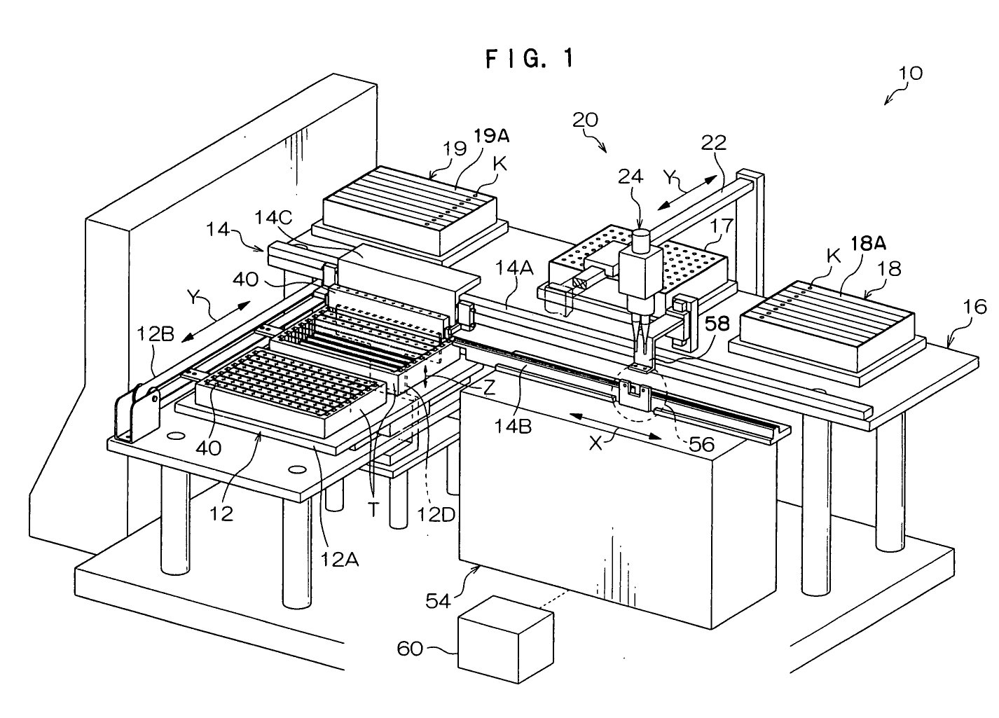

As shown in FIG. 1, the biosensor 10 comprises a tray holding part 12, a transferring part 14, a container platform 16, a liquid supply/discharge part 20, a holding-down part 26, an optical measuring section 54, and a control section 60.

The tray holding part 12 is configured to comprise a platform 12A, and a belt 12B. The platform 12A is mounted to the belt 12B extended in the direction of arrow Y, and can be moved in the direction of arrow Y by running the belt 12B. On the platform 12A, two trays T are placed, being located. The tray T accommodates eight sensor sticks 40. The sensor stick 40 provides a chip on which the biologically active substance D is attached, and will be described later in detail. Under the platform 12A, a pushing-up mechanism 12D is disposed which pushes up the sensor stick 40 to the position where it is held by a stick holding member 14C later described.

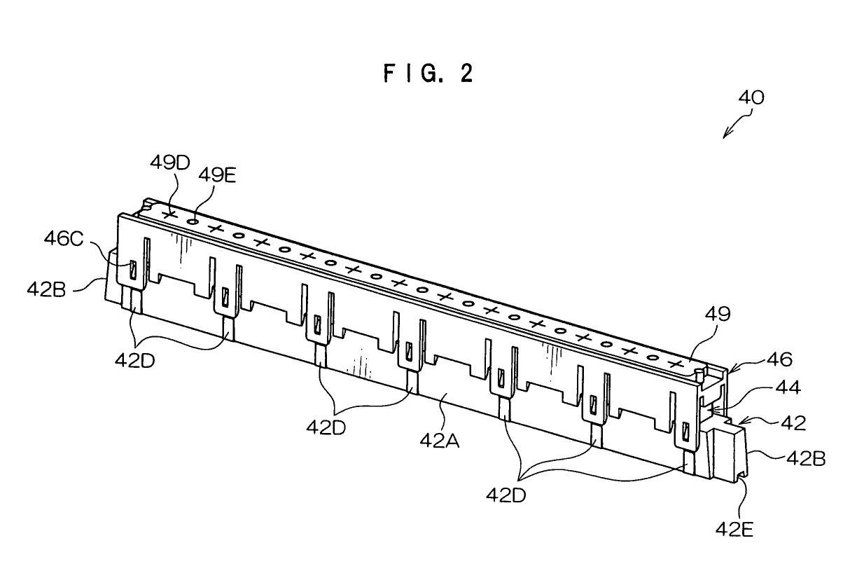

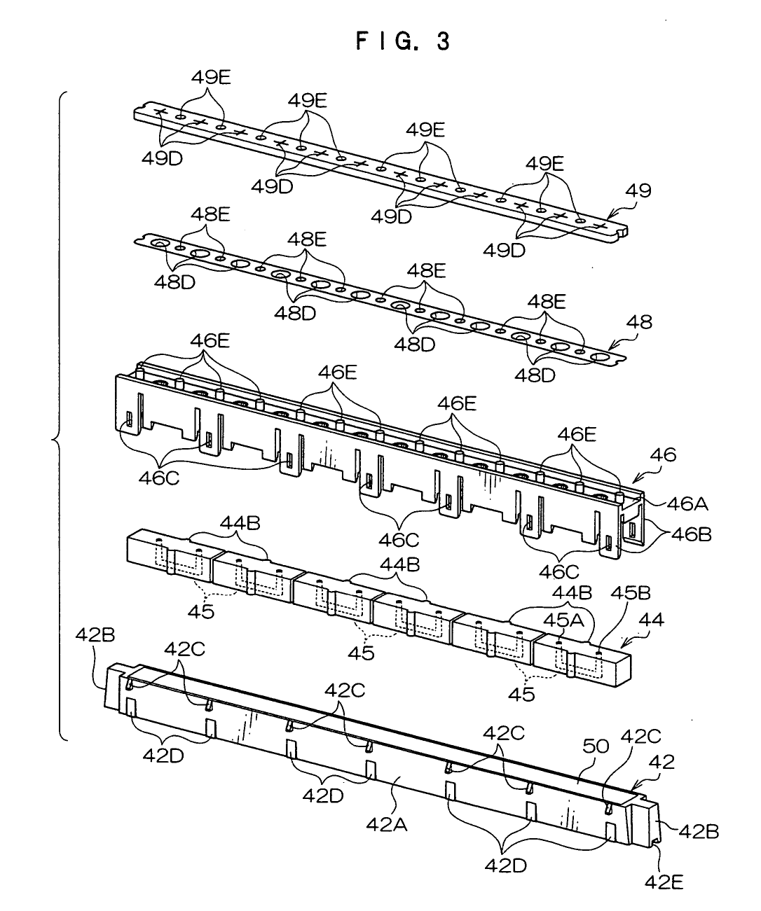

As shown in FIG. 2 and FIG. 3, the sensor stick 40 is made up of a dielectric block 42, a flow path member 44, a holding member 46, an adhesion member 48, and an evaporation prevention member 49.

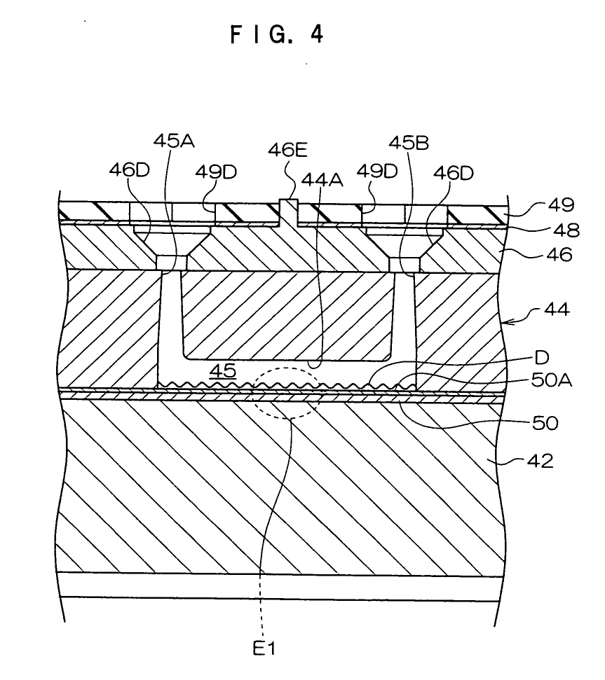

The dielectric block 42 is made up of a transparent resin, or the like, which is transparent to a light beam, comprising a prism part 42A which is formed in the shape of a bar having a trapezoid section, and a to-be-held part 42B at both ends of the prism part 42A that is formed integrally with the prism part 42A. As shown also in FIG. 4, on the top face of the prism part 42A, which is a wider one of the two faces in parallel with each other, a metal film 50 is formed. On this metal film 50, the biologically active substance D which is analyzed with the biosensor 10 is attached. The dielectric block 42 functions as a so-called prism. In measurement with the biosensor 10, a light beam is irradiated to one of the two opposite side faces of the prism part 42A not in parallel with each other, and from the other, the light beam totally reflected at the boundary face of the metal film 50 is emitted.

As shown in FIG. 4, on the surface of the metal film 50, an attachment film 50A is formed. The attachment film 50A is an attachment layer for attaching the biologically active substance D on the metal film 50. The attachment film 50A is selected in accordance with the biologically active substance D to be attached. Examples of substance which can be used as the attachment film 50A include hydrogels, such as agarose, dextran, carrageenan, alginic acid, starch, cellulose, and the like, and derivatives, for example, carboxymethyl derivatives, of these; and water swelling organic polymers, such as polyvinyl alcohol, polyacrylic acid, polyacrylic amide, polyethylene glycol, and the like. Particularly, polyethylene glycol derivatives, and dextran derivatives are preferably used from the viewpoint of bioactivity retention.

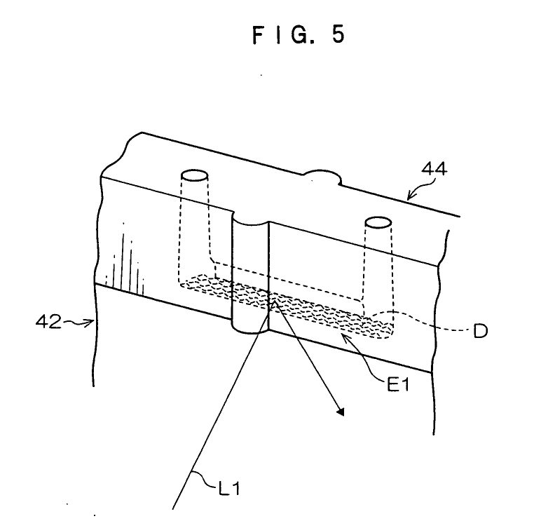

On the attachment film layer 50A, a measurement region (E1) where the biologically active substance D is attached, and the reaction between the compound and the biologically active substance D is measured is formed. To the measurement region E1, a light beam L1 is irradiated as shown in FIG. 5.

On both side faces of the prism part 42A, an engaging convex part 42C which is engaged with the holding member 46, and a vertical convex part 42D which is configured on the extension of an imaginary plane perpendicular to the top face of the prism part 42A are formed in seven places along the lower edge side, respectively. In addition, in the central portion of the bottom face of the dielectric block 42 that is along the longitudinal direction thereof, an engaging groove 42E is formed.

The flow path member 44 is formed as a hexahedron slightly narrower than the dielectric block 42, and as shown in FIG. 3, a plurality of (six in the present embodiment) flow path members 44 are disposed on the metal film 50 on the dielectric block 42, being arranged. In the bottom face of the respective flow path members 44, a flow path groove 44A is formed to communicate into a feed port 45A and a discharge port 45B which are formed in the top face, constituting a liquid flow path 45 with the metal film 50. Thus, for one sensor stick 40, six independent liquid flow paths 45 are provided. On the side wall of the flow path member 44, a convex part 44B to be force fitted into the concave part (not shown) in the inside of the holding member 46 for securing the adherence to the holding member 46 is formed.

It is assumed that, for the liquid flow path 45, a liquid containing protein is supplied, thus it is preferable that, in order to prevent the protein from anchoring to the flow path member 44, the material for the flow path member 44 have no non-specific adsorptivity for proteins.

The holding member 46 is formed in a continuous length, being composed of a top plate 46A and two side plates 46B. In the side plate 46B, engaging holes 46C which are engaged with the engaging convex parts 42C of the dielectric block 42 are formed. The holding member 46 is mounted to the dielectric block 42, sandwiching the six flow path members 44 therebetween, with the engaging hole 46C being engaged with the engaging convex part 42C. Thereby, the flow path members 44 are mounted to the dielectric block 42. In the top plate 46A, a tapered pipette insertion hole 46D which is narrowed down toward the flow path member 44 is formed in the locations opposed to the feed port 45A and the discharge port 45B of the flow path member 44, respectively. In addition, between adjacent pipette insertion holes 46D, a locating boss 46E is formed.

To the top face of the holding member 46, the evaporation prevention member 49 is adhered through the adhesion member 48. In the adhesion member 48, a hole 48D for pipette insertion is formed in the location opposed to the pipette insertion hole 46D, and in the location opposed to the boss 46E, a locating hole 48E is formed. In addition, in the evaporation prevention member 49, a slit 49D, which is a cutout in the shape of a cross, is formed in the location opposed to the pipette insertion hole 46D, and in the location opposed to the boss 46E, a locating hole 49E is formed. By inserting the boss 46E into the holes 48E and 49E for adhering the evaporation prevention member 49 to the top face of the holding member 46, the unit is configured such that the slit 49D in the evaporation prevention member 49 is opposed to the feed port 45A and the discharge port 45B of the flow path member 44, respectively. When a pipette tip CP is not inserted, the slit 49D covers the feed port 45A, preventing the liquid supplied to the liquid flow path 45 from being evaporated. As shown in FIG. 1, the transferring part 14 of the biosensor 10 is configured to comprise an upper guide rail 14A, a lower guide rail 14B, and a stick holding member 14C. The upper guide rail 14A and the lower guide rail 14B are horizontally disposed in the direction of arrow X that is perpendicular to the direction of arrow Y, above the tray holding part 12 and the optical measuring section 54. To the upper guide rail 14A, the stick holding member 14C is mounted. The stick holding member 14C can hold the to-be-held part 42B at both ends of the sensor stick 40, and move along the upper guide rail 14A. The engaging groove 42E in the sensor stick 40 held by the stick holding member 14C and the lower guide rail 14B are engaged with each other, and the stick holding member 14C is moved in the direction of arrow X, whereby the sensor stick 40 is transferred to the measuring section 56 above the optical measuring section 54. In addition, in the measuring section 56, a holding-down member 58 for holding down the sensor stick 40 in measurement is provided. The holding-down member 58 can be moved in the Z direction by a drive mechanism (not shown), and presses the sensor stick 40 disposed in the measuring section 56 from above.

On the container platform 16, a compound solution plate 17, a buffer liquid stock container 18, and a discarding liquid container 19 are placed. The compound solution plate 17 is partitioned in the shape of a matrix for making it possible to stock various compound solutions. The buffer liquid stock container 18 is made up of a plurality of containers 18A, and in the container 18A, an opening K for allowing a later described pipette tip CP to be inserted thereinto is formed. The discarding liquid container 19 is made up of a plurality of containers 19A, in each of which an opening K for allowing the pipette tip CP to be inserted thereinto is formed in the same manner as in the container 18A.

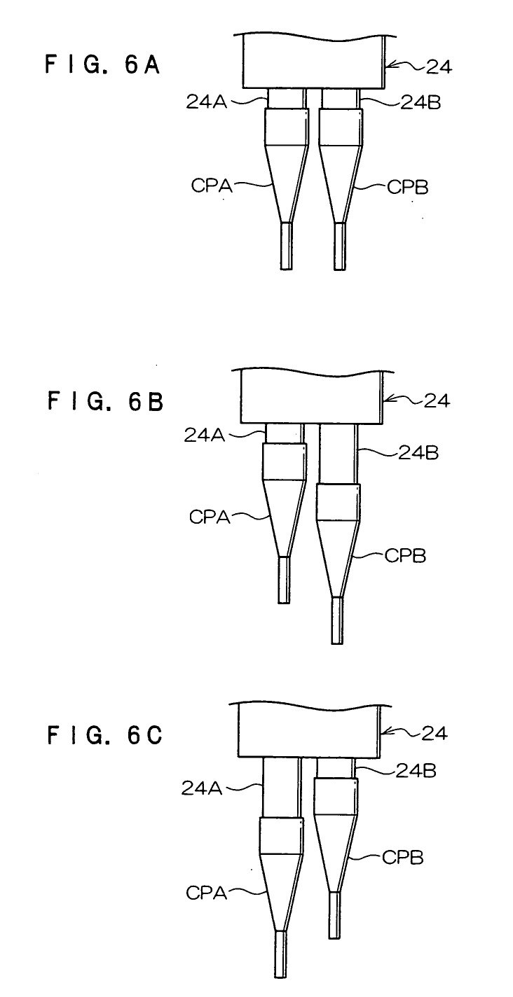

The liquid supply/discharge part 20 is configured to comprise the upper guide rail 14A, the lower guide rail 14B, a traversing rail 22 suspended above these in the direction of arrow Y, and a head 24. The traversing rail 22 can be moved in the direction of arrow X by a drive mechanism (not shown). In addition, the head 24 is mounted to the traversing rail 22, and can be moved in the direction of arrow Y. In addition, the head 24 can be moved also in the vertical direction (in the direction of arrow Z) by a drive mechanism (not shown). As shown in FIG. 6A to FIG. 6C, the head 24 comprises two pipette parts 24A and 24B. To the pipette part 24A, 24B, the pipette tip CP is mounted at the tip part, and the length thereof in the Z direction can be adjusted. A number of pipette tips CP are stocked in a pipette tip stocker (not shown) so as to allow replacement as needed.

In the present embodiment, liquid supply to the sensor stick 40 is carried out by means of the pipette tip CP. However, instead of the pipette tip, an injection tube one end of which is connected to the above-mentioned solution plate, and the other of which can be connected to the sensor stick 40 may be provided for supplying the liquid with a feed pump.

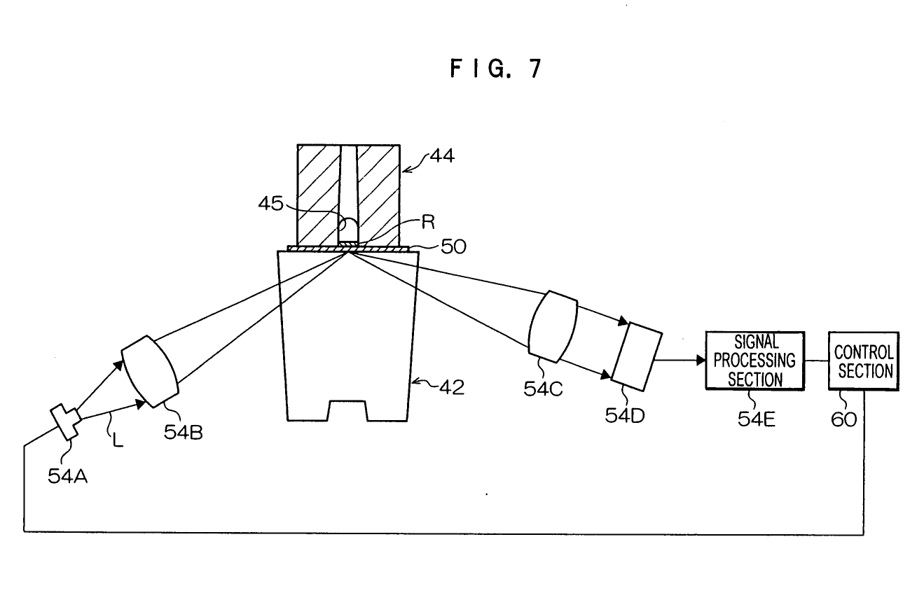

As shown in FIG. 7, the optical measuring section 54 is configured to comprise a light source 54A, a first optical system 54B, a second optical system 54C, a light receiving section 54D, and a signal processing section 54E. From the light source 54A, a light beam L in the diverging state is emitted. The light beam L is irradiated to the measurement region E1 of the dielectric block 42 disposed in the measuring section 56 through the first optical system 54B. In the measurement region E1, the light beam L1 is irradiated, including various incident angle components with respect to the boundary between the metal film 50 and the dielectric block 42, and at an angle of the total reflection angle or larger. The light beam L1 is totally reflected at the boundary between the dielectric block 42 and the metal film 50. The totally reflected light beam L1 is reflected with various reflection angle components. These totally reflected light beam L1 is received by the light receiving section 54D through the second optical system 54C to be photoelectrically converted, and a light detection signal is outputted to the signal processing section 54E. In the signal processing section 54E, a prescribed processing is carried out on the basis of the light detection signal inputted, and the data for total reflection attenuation angle (which is hereinafter to be called the “total reflection attenuation angle data G”) for the measurement region E1 is obtained. This total reflection attenuation angle data G is outputted to the control section 60.

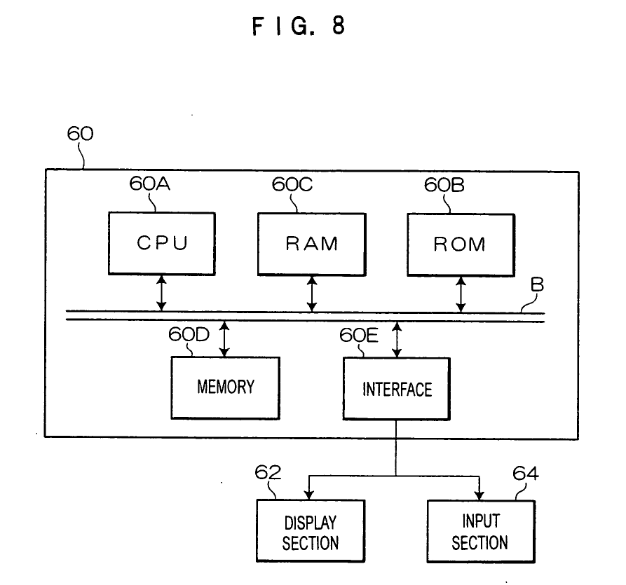

The control section 60 has the function for controlling the entire biosensor 10, and as shown in FIG. 7, is connected to the light source 54A, the signal processing section 54E, and the drive system of the biosensor 10 (not shown). As shown in FIG. 8, the control section 60 has a CPU 60A, an ROM 60B, an RAM 60C, a memory 60D, and an interface 60E which are mutually connected through a bus B, being connected to a display section 62 which displays various pieces of information, and an input section 64 for inputting various instructions and various pieces of information.

[First Measurement Processing]

Next, a first measurement processing with the biosensor 10 will be described.

For carrying out the first measurement processing, various programs, various data, and a correction data base H to control the biosensor 10 are stored in the memory 60D.

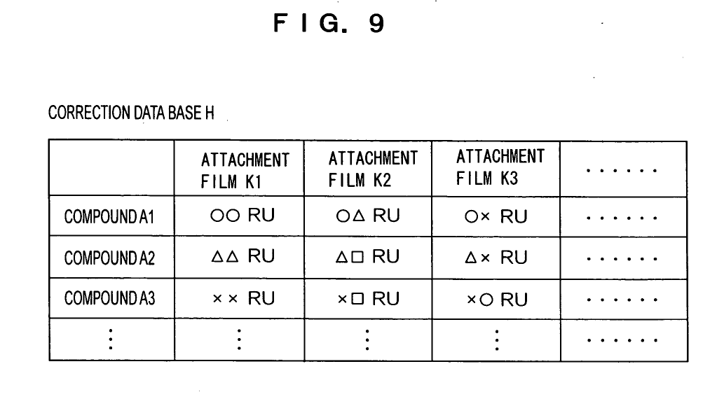

As shown in FIG. 9, the correction data base H stores the reference data N for a particular type of compound corresponding to each of the two or more different types of attachment film 50A, K1, K2, K3, . . . . The reference data N includes the amount of non-specific adsorption of the compound on the attachment film 50A, and is given as a variate between the reference point which is obtained when a running buffer is supplied onto the attachment film 50A on which the biologically active substance D is not attached, and the signal which is obtained when the compound is supplied thereto. For example, in the correction data base H, reference data N when the type of the attachment film 50A is K1, and that of the compound is Al, is given as ◯◯ RU. With the reference data N, the above-mentioned total reflection attenuation angle data G is corrected.

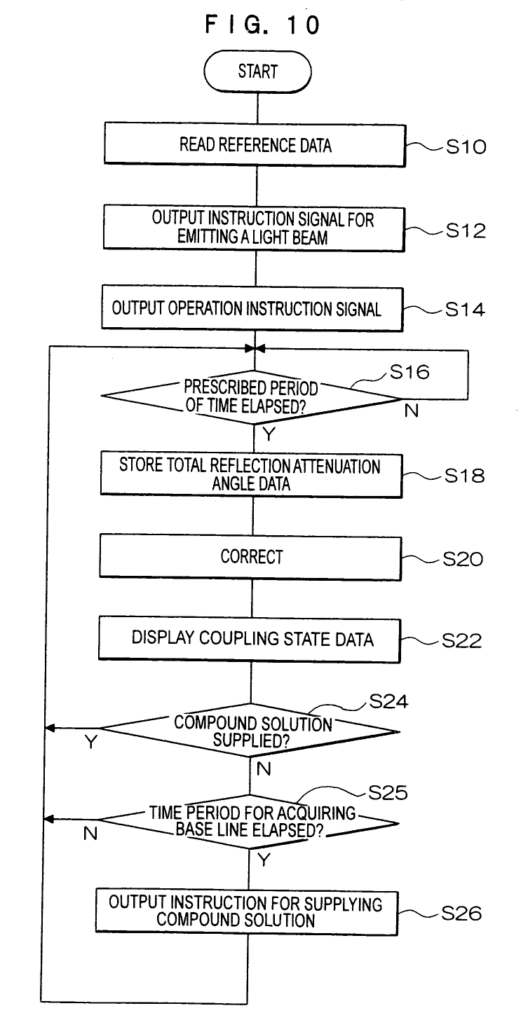

When the sensor stick 40 is transferred to the measuring section 56, and from the input section 64, an instruction for starting the first measurement processing is inputted together with the type of the compound which is the measurement object and that of the attachment film used, the control section 60 excutes the first measurement processing as illustrated in FIG. 10.

First, at step S10, the reference data N corresponding to the type of the compound that has been inputted is read from the correction data base H. Next, at step S12, an instruction signal for emitting a light beam L is outputted to the light source 54A. Thereby, the light beam L is emitted from the light source 54A. The light beam L emitted is changed into a light beam L1 through the first optical system 54B, being irradiated to the measurement region E1 of the liquid flow path 45. In addition, at step S14, an operation instruction signal is outputted to the light receiving section 54D and the signal processing section 54E. Thereby, the light beam L1 which has been totally reflected in the measurement region E1, and passed through the second optical system 54C is received by the light receiving section 54D; the received light is photoelectrically converted; and a light detection signal is outputted to the signal processing section 54E. The signal processing section 54E applies a prescribed processing to the light detection signal to generate total reflection attenuation angle data G, which is outputted to the control section 60.

At step S16, the control section 60 determines whether a prescribed period of time has elapsed, and after the prescribed period of time having elapsed, the total reflection attenuation angle data G inputted is stored in the memory 60D at step S18. And, at step S20, the total reflection attenuation angle data G obtained by the light detection signal from the measurement region E1 is corrected with the reference data N read out to generate coupling state data which indicates the coupling state between the biologically active substance D and the compound in the compound solution. And, at step S22, the coupling state data is outputted to the display section 62. Thereby, every time the prescribed period of time elapses before supplying the compound solution, the coupling state data is stored as the base line in the memory 60D, and displayed on the display section 62.

Next, at step S24, whether the compound solution has already been supplied is determined, and when it has not yet been supplied, whether the prescribed time period for acquiring the base line has elapsed is determined at step S25. When the determination is affirmative, the program proceeds to step S26. When the determination is negative, the program returns to step S16 for acquiring the data for the base line.

At step S26, an instruction for supplying the compound solution is given. Thereby, the compound solution is supplied to the liquid flow path 45 with the pipette tip CPA of the head 24, with the conservation liquid filled in the liquid flow path 45 being discharged by the pipette tip CPB.

After the compound solution having been supplied at step S26, the program returns to the step S16, and the above-mentioned processing is repeated. Thereby, every time the prescribed period of time elapses after the compound solution having been supplied, the coupling state data is stored as the base line in the memory 60D, and displayed on the display section 62.

The above-mentioned measurement processing is continued until the measurement processing termination signal is received.

According to the above-mentioned first measurement processing, the reference data N stored in the correction data base H is used for correction of the total reflection attenuation angle data Q thus there is no need for acquiring the data for correction using a reference region besides the measurement region E1, which allows the measurement throughput time to be shortened. In addition, the need for providing a system for reference region measurement is eliminated, thus the structure of the biosensor 10 can be simplified.

In the above processing, the reference data N for each of the two or more different types of compound have been stored for each of the two or more different types of attachment film, however, alternatively, reference data subdivided for each of the pieces of information about the buffer solution and the compound concentration may be stored in order to use reference data to which the set of measuring conditions at the time of measurement is more precisely fitted, for performing correction.

[Second Measurement Processing]

Next, a second measurement processing with the biosensor 10 will be described.

For carrying out the second measurement processing, various programs, various data, and a non-specific adsorption data base H to control the biosensor 10 are stored in the memory 60D.

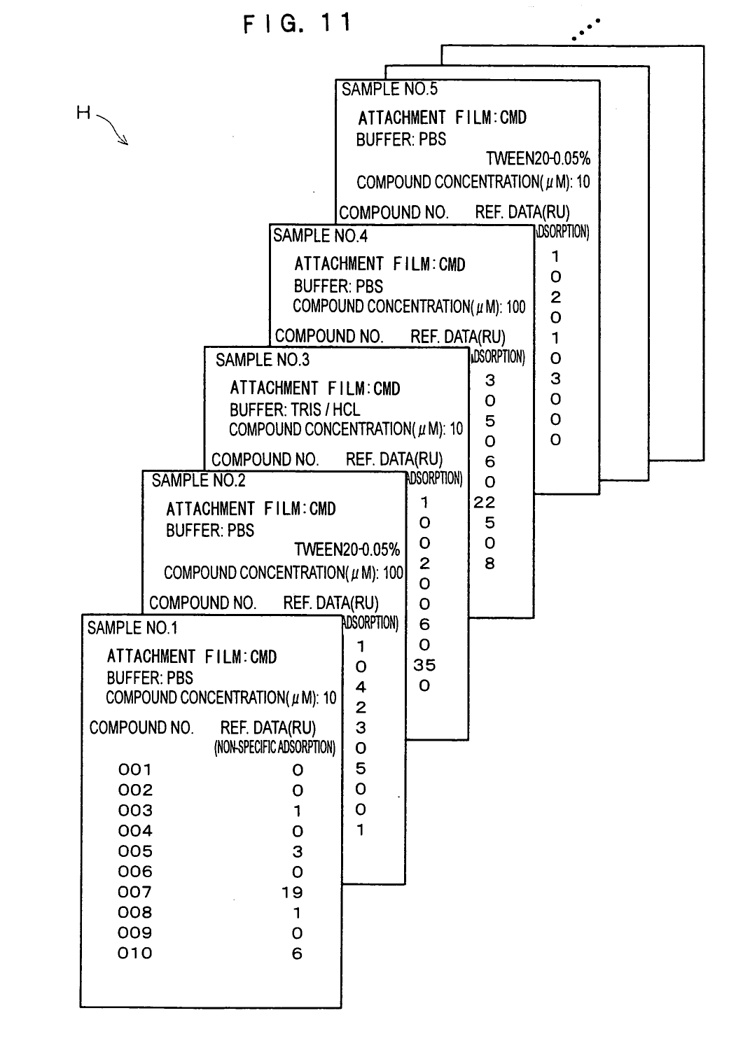

As shown in FIG. 11, in the non-specific adsorption data base H, for each particular set of measuring conditions that is identified by the type of attachment film, the type of buffer, and the compound concentration, and each of a plurality of compounds for that set of measuring conditions, reference data G2 is recorded. The data for a particular set of measuring conditions and a particular compound is hereinafter referred to as sample data SP. The sample data SP is recorded every time the measurement is performed with the biosensor 10, thus the number of pieces of sample data SP being increased every time the measurement is performed. The reference data G2 includes the amount of non-specific adsorption of the compound on the attachment film 50A, and is given as a variate in RU value between the reference point which is obtained when a running buffer is supplied onto the attachment film 50A on which the biologically active substance D is not attached, and the signal which is obtained when the compound is supplied thereto.

In addition, in the memory 60D, a group of compounds which are examination objects are stored. The group of compounds provides a plurality of compounds which are to be examined for interaction with the biologically active substance D, being previously registered by the user.

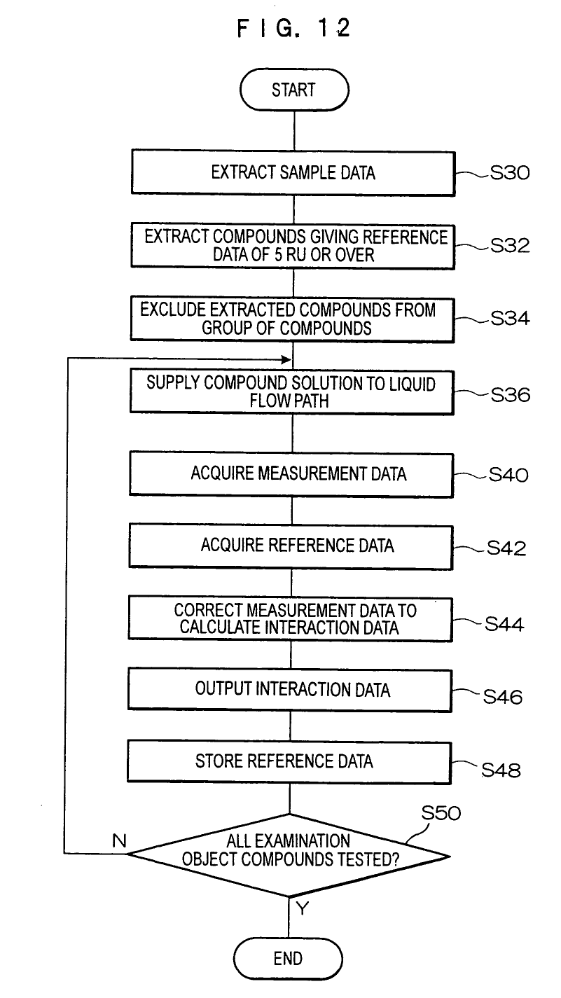

When the sensor stick 40 is transferred to the measuring section 56, and from the input section 64, an instruction for starting the second measurement processing is inputted together with the set of measuring conditions (the type of the attachment film, the type of the buffer, and the compound concentration), the control section 60 excutes the second measurement processing as illustrated in FIG. 12.

First, at step S30, the sample data providing the same set of measuring conditions as that which has been inputted is extracted, and at step S32, from the compounds of this sample data, the compounds which give reference data G2 of 5 RU or over are extracted. And, at step S34, the compounds extracted are excluded from the group of compounds which are examination objects.

For example, when a set of measuring conditions of the attachment film being to be CMD, the buffer being to be PBS, and the compound concentration being to be 10 μM is inputted, the sample No. 1 is extracted from the non-specific adsorption data base H as illustrated in FIG. 11. And, through the examination of the reference data G2 for each compound, the compounds which give reference data G2 of 5 RU or over are extracted. Herein, the compounds No. 7 and No. 10 are extracted because they give 19 RU and 6 RU, respectively. And, they are excluded from the group of compounds which are measurement objects.

In this manner, the compounds which provide a large amount of non-specific adsorption are excluded from the group of compounds which are measurement objects. Herein, the compounds which give reference data G2 of 5 RU or over are excluded, however, the criterion need not always be 5 RU or over, and the user may set an optional threshold value.

Next, at step S36, the solution of a first compound which is an examination object is supplied to the liquid flow path 45; at step S40, the measurement data G1 is acquired from the measurement region E1; and at step S42, the reference data G2 is acquired from the measurement region E2. At step S44, the measurement data G1 is corrected with the reference data G2 to calculate the interaction data G3, and at step S46, the interaction data G3 is outputted to the display section 62. Thereby, the interaction data G3 is displayed on the display section 62.

At step S48, the reference data G2 acquired is stored in the memory 60D together with the set of measuring conditions, and at step S50, whether all the compounds which are the examination objects have been tested is determined. When the determination is negative, the program returns to the step S36 to repeat the above-mentioned processing. When the determination is affirmative, the processing is terminated.

According to the above-mentioned measurement processing, the compounds which provide a large amount of non-specific adsorption are excluded from the compounds which are the examination objects, thus wasteful measurement will not be made, and a high efficiency is assured for the measurement.

In addition, the reference data G2 which has been obtained by the measurement is fed back to the memory 60D, thus for each set of measuring conditions, data for compounds which provide a large amount of non-specific adsorption can be accumulated, and by repeating the measurement, an adequate measurement can be performed on the basis of a number of pieces of reference data.

[Third measurement processing]

Next, a third measurement processing with the biosensor 10 will be described.

For carrying out the third measurement processing, various programs, various data, and a non-specific adsorption data base H to control the biosensor 10 are stored in the memory 60D.

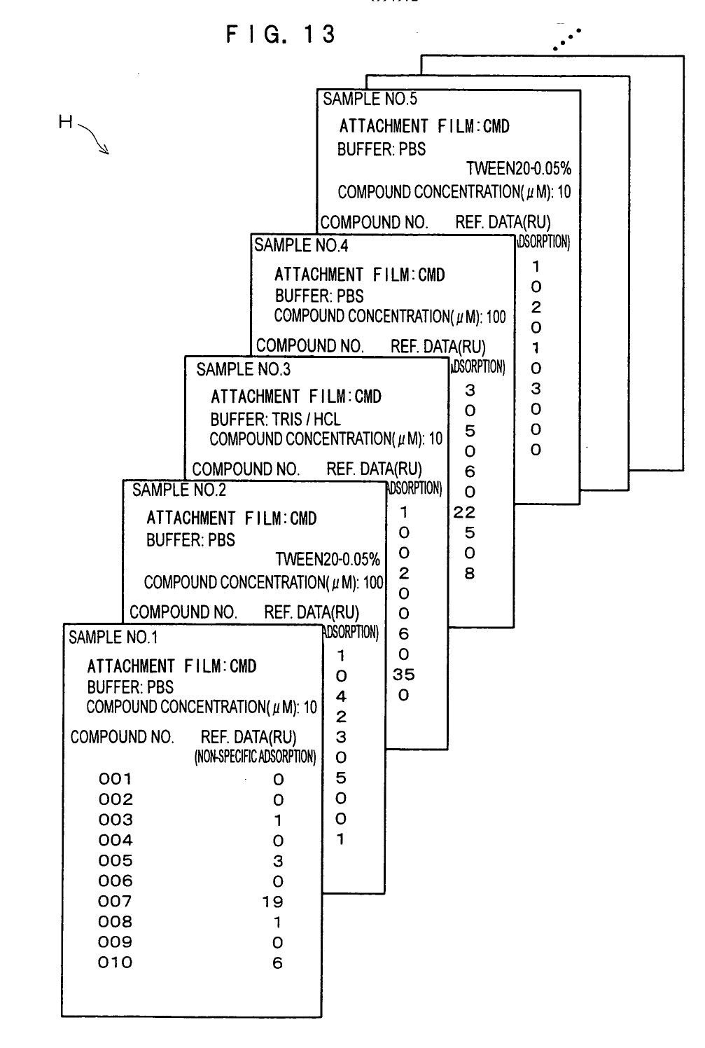

As shown in FIG. 13, in the non-specific adsorption data base H, for each particular set of measuring conditions that is identified by the type of attachment film, the type of buffer, and the compound concentration, and each of a plurality of compounds for that set of measuring conditions, reference data G2 is recorded. The data for a particular set of measuring conditions and a particular compound is hereinafter referred to as sample data SP. The sample data SP is recorded every time the measurement is performed with the biosensor 10, thus the number of pieces of sample data SP being increased every time the measurement is performed. The reference data G2 includes the amount of non-specific adsorption of the compound on the attachment film 50A, and is given as a variate in RU value between the reference point which is obtained when a running buffer is supplied onto the attachment film 50A on which the biologically active substance D is not attached, and the signal which is obtained when the compound is supplied thereto.

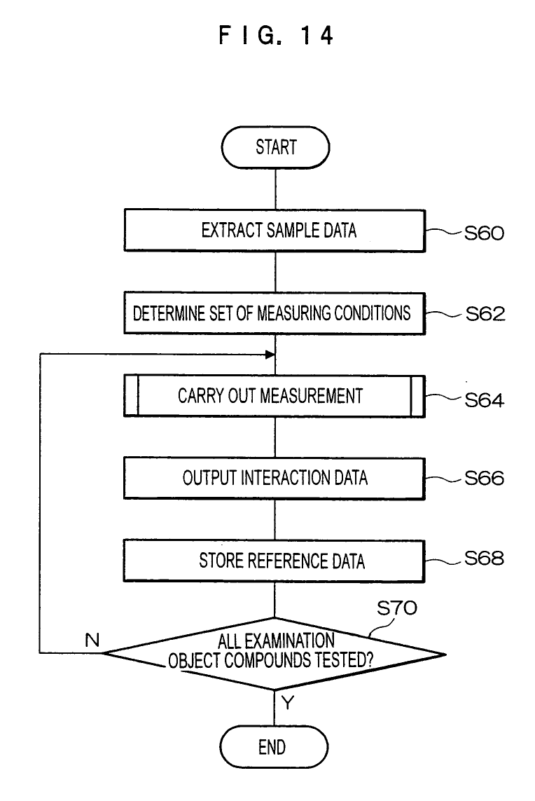

When the sensor stick 40 is transferred to the measuring section 56, and from the input section 64, an instruction for starting the third measurement processing is inputted together with a part of the set of measuring conditions (any two of the type of the attachment film, the type of the buffer, and the compound concentration), the control section 60 excutes the third measurement processing as illustrated in FIG. 14.

First, at step S60, the sample data SP providing the same part of the set of measuring conditions as that which has been inputted is extracted. For example, when the attachment film being to be CMD and the compound concentration being to be 10 μM have been inputted as a part of the set of measuring conditions, the samples No. 1, 3, and 5 are extracted from the non-specific adsorption data base H as illustrated in FIG. 13.

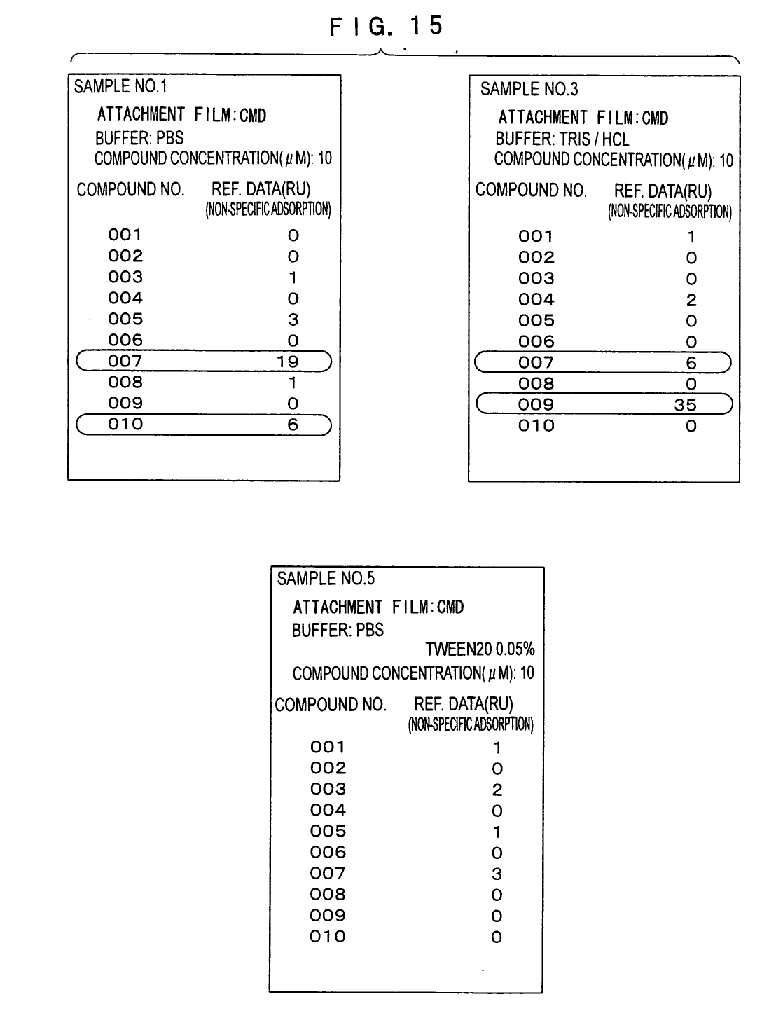

At step S62, through the examination of the reference data G2 for each of the samples No. 1, 3, and 5 extracted, the sample data SP with which the number of compounds giving reference data G2 of 5 RU or over is the fewest is selected, and the set of measuring conditions for the selected sample data SP is determined as the set of measuring conditions for the measurement. For example, as shown in FIG. 15, the sample No. 1 has two compounds Nos. 007 and 010 which give an RU value of 5 or higher; the sample No. 3 has two compounds Nos. 007 and 009; and the sample No. 5 has no compound which gives an RU value of 5 or higher, thus, the sample No. 5 is selected, and the PBS containing 0.05% Tween20 for the sample No. 5 is determined as the buffer liquid. The buffer liquid thus determined provides a buffer liquid which minimizes the non-specific adsorption of the examination object compounds on the attachment film.

In the above processing, the threshold value has been specified to be 5 RU, however, it is not limited to 5 RU, and may be 1 RU or 2 RU, and the user may set it at a discretional value.

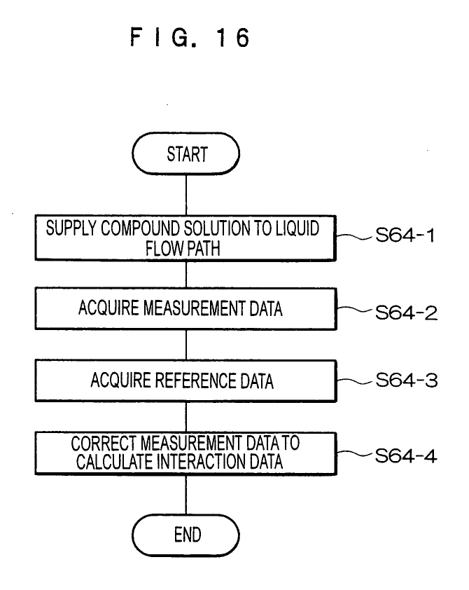

Next, at step S64, the measurement is carried out under the set of measuring conditions that has been determined. As illustrated in FIG. 16, at step S64-1, the solution of a first compound which is an examination object is supplied to the liquid flow path 45; at step S64-2, the measurement data G1 is acquired from the measurement region E1; and at step S64-3, the reference data G2 is acquired from the measurement region E2. At step S64-4, the measurement data G1 is corrected with the reference data G2 to calculate the interaction data G3.

Next, at step S66, the interaction data G3 calculated is outputted to the display section 62. Thereby, the interaction data G3 is displayed on the display section 62.

At step S68, the reference data G2 acquired is stored in the memory 60D together with the set of measuring conditions, and at step S70, whether all the compounds which are the examination objects have been tested is determined. When the determination is negative, the program returns to the step S64 to repeat the above-mentioned processing. When the determination is affirmative, the processing is terminated.

According to the above-mentioned third measurement processing, the set of measuring conditions is determined such that the amount of non-specific adsorption is minimized, thus under the adequate set of measuring conditions, the interaction between the biologically active substance D and the compound can be exactly measured.

In addition, the reference data G2 which has been obtained by the measurement is fed back to the memory 60D, thus for each set of measuring conditions, data for compounds which provide a large amount of non-specific adsorption can be accumulated, and by repeating the measurement, an adequate measurement can be performed on the basis of a number of pieces of reference data.

In the above processing, the set of measuring conditions for the sample data SP with which the number of compounds giving reference data G2 of a prescribed value or higher is the fewest has been selected, however, the above processing may be adapted such that the sample data SP with which the number of compounds giving reference data G2 of a 0 value is the largest, or the sample data SP with which the sum of the values of reference data G2 for all the compounds giving reference data G2 of a prescribed value or under is the smallest is selected.

In addition, in the present embodiment, as one example of the biosensor, the surface plasmon sensor has been described, however, the biosensor is not limited to the surface plasmon sensor. The present invention can be applied to the measurement of the interaction between the biologically active substance D and the compound using any other biosensors, such as those based on the quartz crystal microbalance (QCM) measurement technology, the optical measurement technology using the functionalized surface ranging from that of gold colloidal particles to that of ultrafine particles, and the like, and in any application, the reference data obtained in the reference region may be previously stored, being databased, in order to allow the measurement data acquired to be corrected by means of the stored reference data.

In addition, as an example of other type of biosensor utilizing the total reflection attenuation, the leakage mode detector can be mentioned. The leakage mode detector is made up of a dielectric, and a thin film constituted by a clad layer and a light guiding layer laminated thereon in this order, one face of this thin film providing a sensor face, and the other face a light incident face. When light is irradiated on the light incident face so as to meet the total reflection conditions, a part thereof permeates said clad layer to be introduced into said light guiding layer. And, when the wave-guiding mode is excited in this light guiding layer, the reflected light on said light incident face is greatly attenuated. The incident angle at which the wave-guiding mode is excited varies depending upon the refractive index for the medium on the sensor face as with the surface plasmon resonance angle. By detecting the attenuation of this reflected light, the reaction on said sensor face can be measured.

### EXAMPLES

Next, preparation of an attachment film on the dielectric block which has been explained in the above embodiment, and measurement of the amount of non-specific adsorption of a compound on the attachment film prepared will be described. The preparation of an attachment film, and the measurement of the amount of non-specific adsorption was carried out using a commercially available surface plasmon sensor.

(1) Preparation of Attachment Film

(Preparation of Attachment Film 1)

On the dielectric block on which a metal film was formed, an attachment film 1 made up of a hydrogel film was prepared by the following method.

After the dielectric block having been treated for 30 min with a Model-208 UV-Ozone Cleaning System (TECHNOVISION INC.), a 5.0-mM solution of 11-hydroxy-1-undecanethiol (manufactured by Sigma-Aldrich Corporation) dissolved into ethanol/water (80/20) was added such that it was contacted with the metal film for carrying out surface treatment at 40 deg C. for 30 min, and further at 25 deg C. for 16 hr. Thereafter, cleaning was performed five times with ethanol, once with an ethanol/water mixture solvent, and five times with water.

Next, the surface coated with 11-hydroxy-1-undecanethiol was contacted with a 10%-weight epichlorohydrin solution (the solvent being a 1-to-1 mixture solution of 0.4-M sodium hydroxide and diethyleneglycoldimethylether), and the reaction was progressed in a shaking incubator at 25 deg C. for 4 hr.

Thereafter, the surface was cleaned twice with ethanol, and five times with water. Next, into 40.5 ml of an aqueous solution of 25%-weight dextran (T500, Pharmacia), 4.5 ml of 1-M sodium hydroxide was added, and the solution was contacted with the epichlorohydrin treated surface. Next, in the shaking incubator, incubation was performed at 25 deg C. for 20 hr. The surface was cleaned ten times in water at 50 deg C. Then, a mixture of 3.5 g of bromoacetic acid dissolved into 27 g of a 2-M sodium hydroxide solution was contacted with the above-mentioned dextran treated surface for incubation in the shaking incubator at 28 deg C. for 16 hr. The surface was cleaned with water, and thereafter the above-mentioned procedure was repeated once. This sample was designated an attachment film 1.

(Preparation of Attachment Film 2)

A hydrogel film was prepared in the same manner as that for the attachment film 1, except that the bromoacetic acid treatment was performed once at 28 deg C. This sample was designated an attachment film 2. The attachment film 2 had an introduction rate for COOH group of approx. one third of that for the attachment film 1.

(Preparation of Attachment Film 3)

A hydrogel film was prepared in the same manner as that for the attachment film 1, except that the concentration of dextran was 10% weight. This sample was designated an attachment film 3. The attachment film 3 had an amount of coupling of dextran of approx. one third of that for the attachment film 1.

(2) Measurement of Amount of Non-Specific Adsorption

For measurement chips having the attachment films 1, 2, and 3 prepared as described above, the non-specific adsorptivity for compounds A to C was evaluated by the following method.

The following compound A, compound B, compound C is dissolved into a PBS buffer (10 mM sodium phosphate, 150 mM NaCl, and 0.005% Tween20, pH 7.4)/DMSO 5% solution so as to be 0.01 mM. Through the SPR apparatus, a PBS buffer/DMSO 5% solution is flown as a running buffer for establishing the reference point. Next, the compound A, compound B, compound C solution is flown for 3 min, which is then followed by flowing a PBS buffer/DMSO 5% solution for 3 min. The increment (RU) in SPR signal from the reference point is designated the amount of non-specific adsorption. The measurement results are as given in Table 1.

TABLE 1
Amount of non-specific adsorption of low-molecular weight compound on attachment film

| | Amount of non-specific | Amount of non-specific | Amount of non-specific |
|---|---|---|---|
| | adsorption on | adsorption on | adsorption on |
| | attachment film 1 | attachment film 2 | attachment film 3 |
| Compound A | 14 RU | 5 RU | 10 RU |
| Compound B | 25 RU | 10 RU | 10 RU |
| Compound C | 0 RU | 0 RU | 2 RU |

Compound A

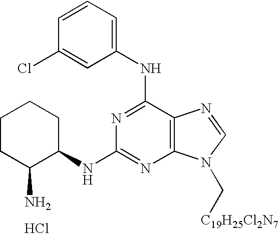

Compound B

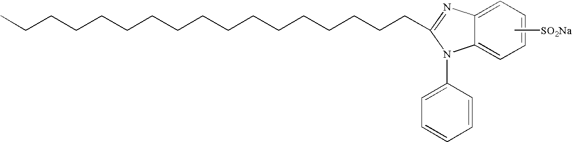

Compound C

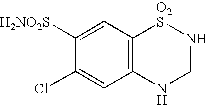

As can be seen from Table 1, the amount of non-specific adsorption of a low-molecular weight compound varies depending upon the constitution of the attachment film and the compound. In addition, variations in ranking of ease of being adsorbed can be seen. Therefore, it is assumed that, for each of the types of attachment film, a data base for the non-specific adsorptivity for low-molecular weight compounds is required.

(3) Amount of non-specific adsorption of compound on attachment film 1

For a measurement chip having the attachment film 1 prepared as described above, the non-specific adsorptivity for compounds was evaluated by the following method.

The above-mentioned compound A, B, C is dissolved into a PBS buffer (10 mM sodium phosphate and 150 mM NaCl, pH 7.4)/DMSO 5% solution so as to be 0.03 mM. Through the SPR apparatus, a PBS buffer/DMSO 5% solution is flown as a running buffer for establishing the reference point. Next, the compound A, B, C solution prepared is flown for 3 min, which is then followed by flowing a PBS buffer/DMSO 5% solution for 3 min. The increment (RU) in SPR signal from the reference point is designated the amount of non-specific adsorption. The measurement results are as given in Table 2. It is obvious that, depending upon the structure of the compound, the amount of non-specific adsorption on the attachment film varies.

(4) Attachment of Protein

A 100-μg/ml (acetic acid buffer pH 5.0) solution of Neutr-Avidin™ (manufactured by PIERCE Biotechnology, Inc.) was prepared. To the above-mentioned measurement chip, a mixture solution of 1-ethyl-2,3-dimethylaminopropyl carbodiimide (400 mM) and N-hydroxysuccineimide (100 mM) was added, and an activation treatment was performed for 2 min or 20 min. After cleaning having been performed with a 10-mM phosphoric acid buffer, the above-mentioned Neutr-Avidin™ solution was added, and the measurement chip was left to stand for 20 min for amine coupling of the Neutr-Avidin™. Further, after cleaning having been performed with a 10-mM phosphoric acid buffer, an ethanolamine-HCl solution (1 M, pH 8.5) was added to the measurement chip, whereby the COOH which was left unreacted with Neutr-Avidin™ was blocked.

By performing the above-mentioned operation, Neutr-Avidin™ was attached on the measurement chip surface by covalent bonding. The variate between the resonance signal (RU value) before the addition of Neutr-Avidin™ and that after the cleaning is given as the amount of Neutr-Avidin™ attachment (RU value) in Table 3. As can be seen from Table 3, the longer the time period provided for activation, the larger the amount of Neutr-Avidin™ attachment will be.

(5) Dependency of Non-Specific Adsorptivity for Compound on Amount of Protein Attachment

For a measurement chip prepared as described above by attaching Neutr-Avidin™ thereon, the non-specific adsorptivity for compounds was evaluated by the following method.

The above-mentioned compound A is dissolved into a PBS buffer (10 mM sodium phosphate and 150 mM NaCl, pH 7.4)/DMSO 5% solution so as to be 0.03 mM. Through the SPR apparatus, a PBS buffer/DMSO 5% solution is flown as a running buffer for establishing the reference point. Next, the compound A solution prepared is flown for 3 min, which is then followed by flowing a PBS buffer/DMSO 5% solution for 3 min. The increment (RU) in SPR signal from the reference point is designated the amount of non-specific adsorption. The measurement results are as given in Table 3.

It is obvious that the larger the amount of attachment of Neutr-Avidin™, the smaller the amount of non-specific adsorption of the compound on the attachment film will be.

TABLE 2
Amount of non-specific adsorption of low-molecular
weight compound on attachment film

| | Amount of non-specific |
|---|---|
| | adsorption on attachment film |
| Compound A | 52 RU |
| Compound B | 36 RU |
| Compound C | 0 RU |

TABLE 3
Relationship among activation time period, amount of protein
attachment, and amount of non-specific adsorption of compound

| | Amount of | Amount of non-specific |
|---|---|---|
| Activation | Neutr-Avidin ™ | adsorption of |
| time period | attachment | compound A |
| (No protein | 0 RU | 97 RU |
| attachment | | |
| operation made) | | |
| 2 min | 1850 RU | 75 RU |
| 20 min | 8300 RU | 20 RU |

As can be seen from Table 2, the amount of non-specific adsorption of a low-molecular weight compound varies depending upon the constitution of the attachment film and the compound. In addition, as can be seen from Table 3, depending upon the amount of protein attachment, variations in the amount of adsorption of the compound on the attachment film can also be seen. Therefore, it is assumed that, for each of the types of attachment film, a data base for the non-specific adsorptivity for compounds is required.

(6) Relation between Measurement Buffer Species and Amount of Non-Specific Adsorption on Attachment Film

The compound A is dissolved into a buffer A, buffer B, buffer C as described below. The respective buffers are prepared in three different concentrations of the compound of 1 μM, 10 μM, and 100 μM.

Buffer A: 10-mM sodium phosphate, 150-Mm NaCl, pH 7.4, DMSO 5%; buffer B: 10-mM sodium phosphate, 150-mM NaCl, 0.005% Tween20, pH 7.4, DMSO 5%; buffer C: 10-mM Tris-HCl, 150-mM NaCl, pH 8.0, DMSO 5%.

Through the SPR apparatus, the running buffer which is of the same species as that of the buffer into which the compound A is dissolved is flown for establishing the reference point. Next, the compound A solution prepared is flown for 3 min, which is then followed by flowing the running buffer which is of the same species as that of the buffer into which the compound A is dissolved, for 3 min. The increment (RU) in SPR signal from the reference point is designated the amount of non-specific adsorption. The measurement results are as given in Table 4.

TABLE 4
Relation between buffer species and amount of non-specific adsorption
of low-molecular weight compound on attachment film

| | Concentration of compound A | | |
|---|---|---|---|
| | 1 μM | 10 μM | 100 μM |
| Buffer A | 16 RU | 52 RU | 190 RU |
| Buffer B | 3 RU | 13 RU | 48 RU |
| Buffer C | 9 RU | 36 RU | 130 RU |

Depending upon the composition of the buffer, the amount of non-specific adsorption of a low-molecular weight compound on the attachment film may remarkably vary.

As can be seen from the above description, the amount of non-specific adsorption of a low-molecular weight compound varies depending upon the constitution of the attachment film and the compound. In addition, depending upon the amount of protein attachment, variations in the amount of adsorption of the compound on the attachment film can also be seen. Therefore, it is assumed that, for each of the types of attachment film and each of the species of buffer solution, a data base for the non-specific adsorptivity for compounds is required.

What is claimed is:

1. A measuring apparatus which, on the basis of measurement data which is obtained by supplying an examination object compound to a measurement region in which a biologically active substance is attached on an attachment film, and reference data including information about the amount of non-specific adsorption of said compound on said attachment film that is obtained by supplying said compound to a reference region made up of said attachment film on which said biologically active substance is not attached, measures the interaction between said biologically active substance and said compound, the apparatus comprising:
a memory section which stores, in advance, said reference data for two or more types of said examination object compound for each said compound;
a measuring section which supplies said compound to the biologically active substance attached on said attachment film and measures the interaction of said compound with said attachment film on which said biologically active substance is attached;
a calculation section which corrects the measurement data obtained by measurement by said measuring section with said reference data corresponding to said compound to calculate interaction data for the interaction between said biologically active substance and said compound; and
an output section which outputs the interaction data calculated by said calculation section.

2. The measuring apparatus of claim 1, wherein said attachment film is formed on a metal film; and
said measuring section utilizes the total reflection attenuation caused by irradiating a light beam to the side of said metal film on which said attachment film is not formed, for measuring the interaction of said compound with said attachment film on which said biologically active substance is attached.

3. A measuring method which, on the basis of measurement data which is obtained by supplying an examination object compound to a measurement region in which a biologically active substance is attached on an attachment film, and reference data including information about the amount of non-specific adsorption of said compound on said attachment film that is obtained by supplying said compound to a reference region made up of said attachment film on which said biologically active substance is not attached, measures the interaction between said biologically active substance and said compound, the method comprising:
storing said reference data for two or more previously determined types of said examination object compound, so as to provide a correspondence with each said compound;
supplying said compound to the biologically active substance attached on said attachment film and measuring the interaction of said compound with said attachment film on which said biologically active substance is attached;
correcting the measurement data obtained by said measurement with said reference data corresponding to said compound to calculate interaction data for the interaction between said biologically active substance and said compound; and
outputting said calculated interaction data.

4. The measuring method of claim 3, wherein said measurement utilizes the total reflection attenuation caused by irradiating a light beam on a metal film, which has said attachment film formed on one face thereof, at a side of the metal film at which said attachment film is not formed, for measuring the interaction of said compound with said attachment film on which said biologically active substance is attached.

5. A measuring apparatus which, on the basis of measurement data which is obtained by supplying an examination object compound to a measurement region in which a biologically active substance is attached on an attachment film, and reference data including information about the amount of non-specific adsorption of said compound on said attachment film that is obtained by supplying said compound to a reference region made up of said attachment film on which said biologically active substance is not attached, measures the interaction between said biologically active substance and said compound, the apparatus comprising:
a memory section which stores said reference data for each set of measuring conditions and each said compound;
a measuring condition input section which inputs a set of measuring conditions for said measurement;
a compound extraction section which extracts the compounds corresponding to the reference data exceeding a prescribed non-specific adsorptivity level of said reference data which corresponds to said inputted set of measuring conditions;
a measuring section which supplies each of the compounds except the compounds extracted by said compound extraction section from a group of examination object compounds, to said measurement region and said reference region to acquire the measurement data from said measurement region and the reference data from said reference region, and measure the interaction between said biologically active substance and the supplied compound;
an output section which outputs interaction data for the interaction measured by said measuring section; and
a feedback section which causes the reference data obtained by said measuring section to be stored in said memory section together with the set of measuring conditions in said measurement.

6. The measuring apparatus of claim 5, wherein said attachment film is formed on a metal film; and
said measuring section utilizes the total reflection attenuation caused by irradiating a light beam to the side of said metal film on which said attachment film is not formed, for measuring the interaction of said compound with said attachment film on which said biologically active substance is attached.

7. A measuring method which, on the basis of measurement data which is obtained by supplying an examination object compound to a measurement region in which a biologically active substance is attached on an attachment film, and reference data including information about the amount of non-specific adsorption of said compound on said attachment film that is obtained by supplying said compound to a reference region made up of said attachment film on which said biologically active substance is not attached, measures the interaction between said biologically active substance and said compound, the method comprising:
storing said reference data for each set of measuring conditions and each said compound,
inputting a set of measuring conditions for said measurement;
extracting the compounds corresponding to the reference data exceeding a prescribed non-specific adsorptivity level of said reference data which corresponds to said inputted set of measuring conditions;
supplying each of the compounds except the compounds extracted by said compound extraction section from a group of examination object compounds, to said measurement region and said reference region to acquire the measurement data from said measurement region and the reference data from said reference region, and measure the interaction between said biologically active substance and the supplied compound;
outputting interaction data for the interaction measured by said measurement; and
causing the reference data obtained by said measurement part to be stored together with the set of measuring conditions in said measurement.

8. The measuring method of claim 7, wherein said measurement utilizes the total reflection attenuation caused by irradiating a light beam on a metal film, which has said attachment film formed on one face thereof, at a side of the metal film at which said attachment film is not formed, for measuring the interaction of said compound with said attachment film on which said biologically active substance is attached.

9. A measuring apparatus which, on the basis of measurement data which is obtained by supplying an examination object compound to a measurement region in which a biologically active substance is attached on an attachment film, and reference data including information about the amount of non-specific adsorption of said compound on said attachment film that is obtained by supplying said compound to a reference region made up of said attachment film on which said biologically active substance is not attached, measures the interaction between said biologically active substance and said compound, the apparatus comprising:
a memory section which stores said reference data for each set of measuring conditions and each said compound;
a measuring condition input section which inputs a part of a set of measuring conditions for said measurement;
a measuring condition determination section which, on the basis of said reference data corresponding to said inputted part of the set of measuring conditions, determines the other measuring condition such that the non-specific adsorption of the examination object compound on said attachment film is minimized;
a measuring section which, under said determined set of measuring conditions, measures the interaction between said biologically active substance and the supplied compound;
an output section which outputs interaction data for the interaction measured by said measuring section; and
a feedback section which causes the reference data obtained by said measuring section to be stored in said memory section together with the set of measuring conditions in said measurement.

10. The measuring apparatus of claim 9, wherein said attachment film is formed on a metal film, and
said measuring section utilizes the total reflection attenuation caused by irradiating a light beam to the side of said metal film on which said attachment film is not formed, for measuring the interaction of said compound with said attachment film on which said biologically active substance is attached.

11. A measuring method which, on the basis of measurement data which is obtained by supplying an examination object compound to a measurement region in which a biologically active substance is attached on an attachment film, and reference data including information about the amount of non-specific adsorption of said compound on said attachment film that is obtained by supplying said compound to a reference region made up of said attachment film on which said biologically active substance is not attached, measures the interaction between said biologically active substance and said compound, the method comprising:
storing said reference data for each set of measuring conditions and each said compound;
inputting a part of a set of measuring conditions for said measurement;
on the basis of said reference data corresponding to said inputted part of the set of measuring conditions, determining the other measuring condition such that the non-specific adsorption of the examination object compound on said attachment film is minimized;
under said determined set of measuring conditions, measuring the interaction between said biologically active substance and the supplied compound;
outputting interaction data for the interaction measured by said measurement; and
causing the reference data obtained by said measurement to be stored together with the set of measuring conditions in said measurement.

12. The measuring method of claim 11, wherein said measurement utilizes the total reflection attenuation caused by irradiating a light beam on a metal film, which has said attachment film formed on one face thereof, at a side of the metal film at which said attachment film is not formed, for measuring the interaction of said compound with said attachment film on which said biologically active substance is attached.
